(19) United States
(12) Patent Application Publication
(10) Pub. No.: US 2020/0388003 A1
(43) Pub. Date: Dec. 10, 2020

(54) PRODUCING 360 DEGREE IMAGE CONTENT ON RECTANGULAR PROJECTION IN ELECTRONIC DEVICE USING PADDING INFORMATION

(71) Applicant: SAMSUNG ELECTRONICS CO., LTD., Suwon-si (KR)

(72) Inventors: Amith DSOUZA, Bangalore (IN); Anubhav SINGH, Bangalore (IN); Sri Nitchith AKULA, Eluru (IN); Ramkumaar Kovil KANDHADAI, Bangalore (IN); Chirag PUJARA, Bangalore (IN); Raj Narayana GADDE, Bangalore (IN); Elena ALSHINA, Seoul (KR); Kwang Pyo CHOI, Seoul (KR)

(73) Assignee: SAMSUNG ELECTRONICS CO., LTD., Suwon-si (KR)

(21) Appl. No.: 16/638,381

(22) PCT Filed: Oct. 10, 2018
(86) PCT No.: PCT/KR2018/011879

§ 371 Date: Feb. 11, 2020

(30) Foreign Application Priority Data
Oct. 9, 2017 (IN) 201741035759
Oct. 5, 2018 (IN) 2017 41035759

(51) Int. Cl. G06T 3/00; G06T 5/00; G06T 7/00; G06T 5/50

(52) U.S. Cl. CPC G06T 3/0062; G06T 5/005; G06T 3/0087; G06T 5/50; G06T 7/97

(57) ABSTRACT

Embodiments herein disclose a method for producing 360 degree image content on a rectangular projection in an electronic device. The method includes obtaining a 360 degree image content represented by packing one or more projection segments arranged in a rectangular projection. The method includes detecting whether at least one discontinuous boundary is present in the 360-degree image content. The at least one discontinuous boundary is detected using the packing of one or more projection segments. The method includes applying at least one padding information on the at least one discontinuous boundary. The method includes producing another 360 degree image content on the rectangular projection in the electronic device based on the padding information.

### TECHNICAL FIELD

The present disclosure related to an image processing system, and more specifically related to a method and system for producing 360 degree image content on a rectangular projection in an electronic device using padding information.

### BACKGROUND ART

Virtual reality (VR) based entertainment/gaming is a consumer application that is increasing exponentially in popularity. Typical VR videos/games are played in high resolution (4K) and these are processed on an electronic device (e.g., smart phone, virtual reality (VR) device or the like). Thus, network bandwidth and processing power/battery life are two major problems faced while implementing a VR pipeline (i.e., capture—encode—transmit—decode—playback). Further, a 360 degree image content (e.g., 360 videos or the like) are represented in a two dimensional (2D) for encoding and transmission. Various projection formats (e.g., equi-rectangular Projection (ERP) format, Icosahedron format, octahedral format, Padded Equi-rectangular Projection (PERP), cube mapping format or the like) are used for representing the 360 degree image content for encoding using conventional codecs. Various projection formats are packed into a rectangular frame to enable efficient encoding. In an example, sample frame packing formats and discontinuities are depicted as shown in the FIG. 1. The notation “A” of the FIG. 1 depicts the compact ISP format, and the notation “B” of the FIG. 1 depicts a cubemap format.

Further, frame packing methods introduce discontinuities in the frame. In order to avoid bleeding across the edges and avoid coding artifacts, padding is introduced across the discontinuous edges. It is advisable to maintain discontinuities along block boundaries to avoid bleeding across the discontinuous edge. This requires different padding sizes for different resolutions. In an example, the seams are aligned to a coding unit (CU) boundary by varying padding sizes for different resolution is depicted as shown in the FIG. 2. The seams are aligned to a largest coding unit (LCU) boundary are depicted as shown in the FIG. 3. The discontinuity in a Rotated Sphere Projection (RSP) format is depicted as shown in the FIG. 4. The boundary discontinuity in the ERP format is depicted as shown in the FIG. 5.

Thus, it is desired to address the above mentioned disadvantages or other shortcomings or at least provide a useful alternative.

### DISCLOSURE

### Technical Solution

Embodiments herein disclose a method for producing 360 degree image content on a rectangular projection in an electronic device. The method includes obtaining a 360 degree image content represented by packing one or more projection segments arranged in a rectangular projection. The method includes detecting whether at least one discontinuous boundary is present in the 360-degree image content. The at least one discontinuous boundary is detected using the packing of one or more projection segments. The method includes applying at least one padding information on the at least one discontinuous boundary. The method includes producing another 360 degree image content on the rectangular projection in the electronic device based on the padding information.

### Advantageous Effects

The principal object of the embodiments herein provides a method and system for producing 360 degree image content on a rectangular projection in an electronic device.

Another object of the embodiments is to obtain a 360 degree image content represented by packing one or more projection segments arranged in the rectangular projection.

Another object of the embodiments is to detect whether at least one discontinuous boundary is present in the 360-degree image content.

Another object of the embodiments is to apply at least one padding information on the at least one discontinuous boundary.

Another object of the embodiments is to produce another 360 degree image content on the rectangular projection in the electronic device based on the padding information.

### DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is an example scenario in which sample frame packing formats and discontinuities are depicted;

FIG. 2 is an example scenario in which seams is aligned to a CU boundary by varying padding sizes for different resolution;

FIG. 3 is an example scenario in which seams is aligned to a LCU boundary;

FIG. 4 is an example scenario in which discontinuity in a RSP format is depicted;

FIG. 5 is an example scenario in which boundary discontinuity in an ERP format is depicted;

FIG. 6 is a block diagram of an electronic device, according to embodiments as disclosed herein;

FIG. 7 is a block diagram of a 360 degree image content generator, according to embodiments as disclosed herein;

FIG. 8 is a flow diagram illustrating a method for producing 360 degree image content on a rectangular projection in the electronic device, according to embodiments as disclosed herein;

FIG. 9 is an example scenario in which a viewport is generated from a padded ERP format when a padding size is not known;

FIG. 10 is an example scenario in which the viewport is generated from padded ERP format when a padding size is known, according to embodiments as disclosed herein;

FIG. 11 is an example scenario in which the viewport is generated for a high motion sequence, according to embodiments as disclosed herein;

FIG. 12 is an example scenario in which the viewport is generated for a low motion sequence, according to embodiments as disclosed herein;

FIG. 13 is an example scenario in which the viewport is generated for a 8-pixel padding, according to embodiments as disclosed herein;

FIG. 14 is an example scenario in which the viewport is generated for a 16-pixel padding, according to embodiments as disclosed herein;

FIG. 15 is an example scenario in which padding regions are depicted in a Cube-map based formats, according to embodiments as disclosed herein;

FIG. 16 is an example scenario in which padded region are depicted in an Equi-rectangular projection format, according to embodiments as disclosed herein;

FIG. 17 is an example scenario in which padded region are depicted in rotated sphere projection format, according to embodiments as disclosed herein;

FIG. 18 is an example flow diagram illustrating various operations for applying the padding information on the at least one discontinuous boundary in the Equi-rectangular projection format, according to embodiments as disclosed herein; and

FIG. 19 is an example flow diagram illustrating various operations for applying the padding information on the at least one discontinuous boundary in the cubemap based projection format, according to embodiments as disclosed herein.

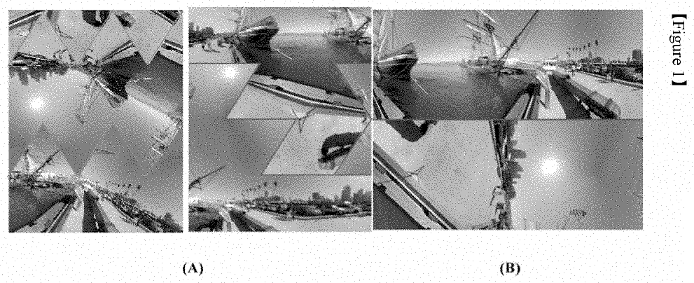

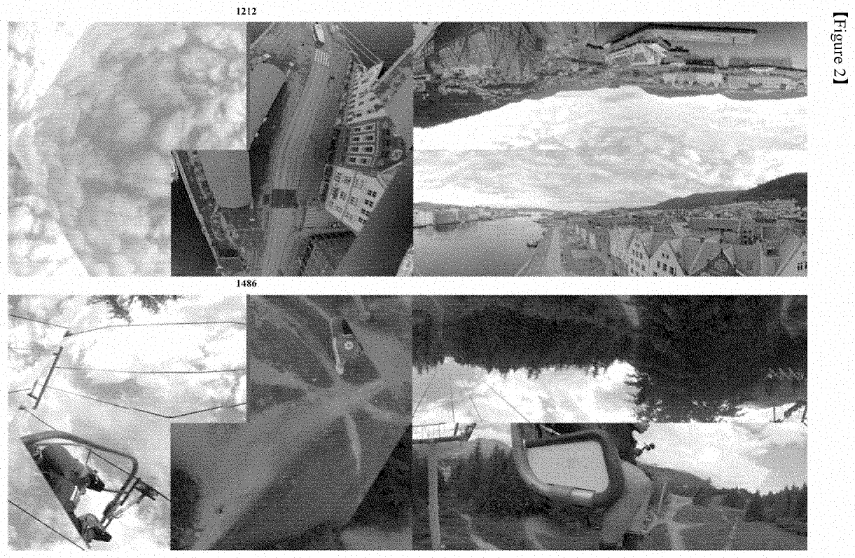

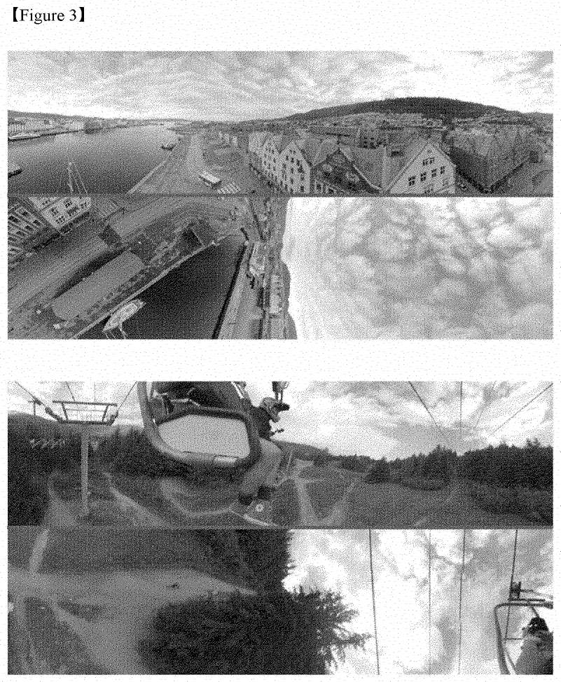

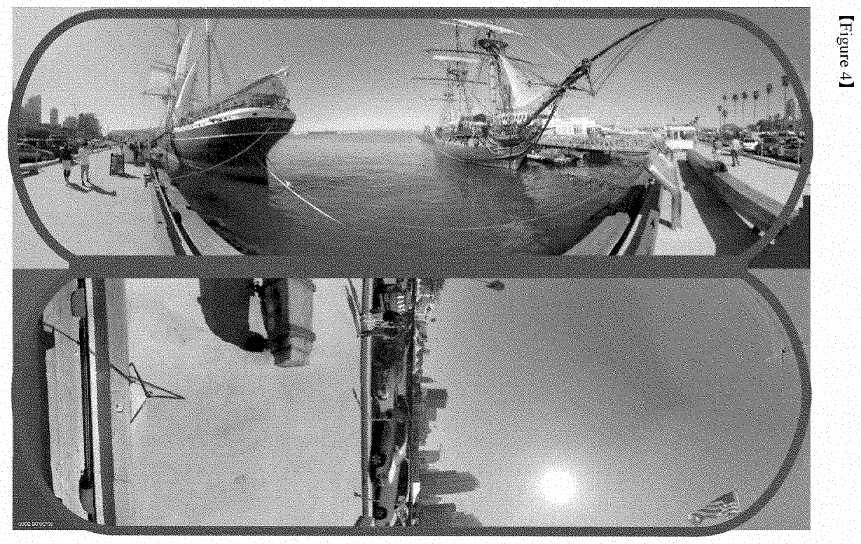

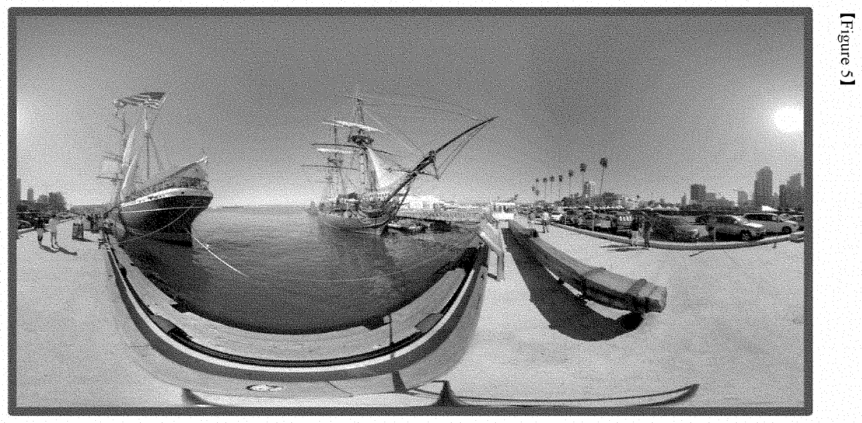

### BEST MODE

Accordingly, embodiments herein disclose a method for producing 360 degree image content on a rectangular projection in an electronic device. The method includes obtaining a 360 degree image content represented by packing one or more projection segments arranged in a rectangular projection. The method includes detecting whether at least one discontinuous boundary is present in the 360-degree image content. The at least one discontinuous boundary is detected using the packing of one or more projection segments. The method includes applying at least one padding information on the at least one discontinuous boundary. The method includes producing another 360 degree image content on the rectangular projection in the electronic device based on the padding information.

In an embodiment, the at least one padding information is obtained based on one of a signaling message and a metadata associated with the signaling message.

In an embodiment, the signaling message could include at least one of supplemental enhancement information (SEI) message, a Sequence Parameter Set (SPS) message, a Picture Parameter Set (PPS) message, and a Video Parameter Set (VPS) message.

In an embodiment, the at least one padding information provides information about remapping at least one color sample of the 360 degree image content onto the rectangular projection.

In an embodiment, the at least one padding information includes at least one of a padding cancel parameter, a padding persistence parameter, a presence boundary indicating parameter, a boundary type, and a Chroma sample range value.

In an embodiment, the at least one padding information is applied on the at least one discontinuous boundary to manage a bleeding effect across the at least one discontinuous boundary in the another 360 degree image content.

In an embodiment, applying the at least one padding information on the at least one discontinuous boundary includes obtaining a set of frames, computing a difference value between a first frame from the set of frames and a second frame from the set of frames, determining whether the difference value between the first frame from the set of frames and the second frame from the set of frames meets a predefined value, and applying the at least one padding information on the at least one discontinuous boundary based on the determination.

In an embodiment, the predefined value is computed as a function of a characteristic of the set of frames.

In an embodiment, the at least one padding information is applied on the at least one discontinuous boundary based on at least one of a size of a frame, a format of the projection segments, a resolution of the 360 degree image content, and an information about a projection type.

In an embodiment, the at least one padding information is applied on the at least one discontinuous boundary to align the at least one discontinuous boundary to at least one of a coding unit (CU) and a largest coding unit (LCU).

In an embodiment, the at least one padding information corresponds to at least one of a boundary based padding information and an internal based padding information.

Accordingly, embodiments herein disclose an electronic device for producing 360 degree image content on a rectangular projection. The electronic device includes a 360 degree image content generator coupled with a processor and a memory. The 360 degree image content generator is configured to obtain a 360 degree image content represented by packing one or more projection segments arranged in a rectangular projection. Further, the 360 degree image content generator is configured to detect whether at least one discontinuous boundary is present in the 360-degree image content. The at least one discontinuous boundary is detected using the packing of one or more projection segments. The 360 degree image content generator is configured to apply at least one padding information on the at least one discontinuous boundary. Further, the 360 degree image content generator is configured to produce another 360 degree image content on the rectangular projection in the electronic device based on the padding information.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### MODE FOR INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the invention. Likewise, the blocks of the embodiments may be physically combined into more complex blocks without departing from the scope of the invention

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, embodiments herein achieve a method for producing 360 degree image content on a rectangular projection in an electronic device. The method includes obtaining a 360 degree image content represented by packing one or more projection segments arranged in a rectangular projection. The method includes detecting whether at least one discontinuous boundary is present in the 360-degree image content. The at least one discontinuous boundary is detected using the packing of one or more projection segments. The method includes applying at least one padding information on the at least one discontinuous boundary. The method includes producing another 360 degree image content on the rectangular projection in the electronic device based on the padding information.

Unlike conventional methods and systems, the proposed method can be used to produce the 360 degree image content (e.g., 360 stereoscopic video, monoscopic video or the like) on the rectangular projection in a VR application with less computing operations. Based on the padding information, a renderer of the electronic device can accurately render the 360 degree image content. The method can be used for coding continuous sequence of frames using frame redundancies to reduce file size.

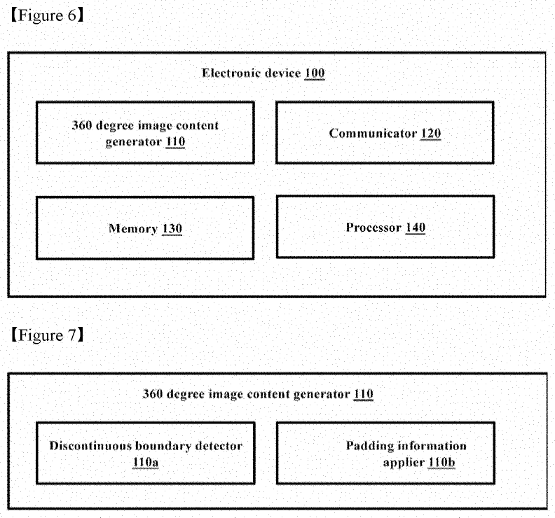

Referring now to the drawings, and more particularly to FIGS. 6 through 19, where similar reference characters denote corresponding features consistently throughout the figures, there are shown preferred embodiments.

FIG. 6 is a block diagram of an electronic device 100, according to embodiments as disclosed herein. The electronic device 100 can be, for example, but not limited to a smart phone, a VR headset, a laptop, smart watch or the like. In an embodiment, the electronic device 100 includes a 360 degree image content generator 110, a communicator 120, a memory 130 and a processor 140. The processor 140 is communicated with the 360 degree image content generator 110, the communicator 120, and the memory 130.

The 360 degree image content generator 110 is configured to obtain a 360 degree image content represented by packing one or more projection segments arranged in a rectangular projection. Further, the 360 degree image content generator 110 is configured to detect whether at least one discontinuous boundary is present in the 360-degree image content. The at least one discontinuous boundary is detected using the packing of one or more projection segments.

In an example, the discontinous boundary is detected based on the following procedure:

1. If projection format is Equi-Rectangular Projection (ERP), following are the discontinuous boundaries.

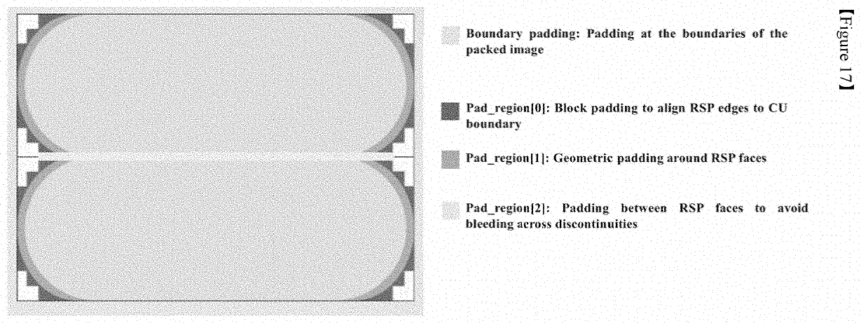

a. Discontinous boundary left at x=0, y=[0:image height] denoted as boundary_pad_left in the FIG. 16,

b. Discontinous boundary right at x=image width, y=[0:image height] denoted as boundary_pad_right in the FIG. 16,

c. Discontinous boundary top at x=[0:image width], y=0 denoted as boundary_pad_top in the FIG. 16, and

d. Discontinous boundary bottom at x=[0:image width], y=image height denoted as boundary_pad_bottom in the FIG. 16.

2. If projection format is Cubemap Projection (CMP)/Modified Cubemap Projection (MCP) or other variants of cubemap format, the following are the discontinuous boundaries:

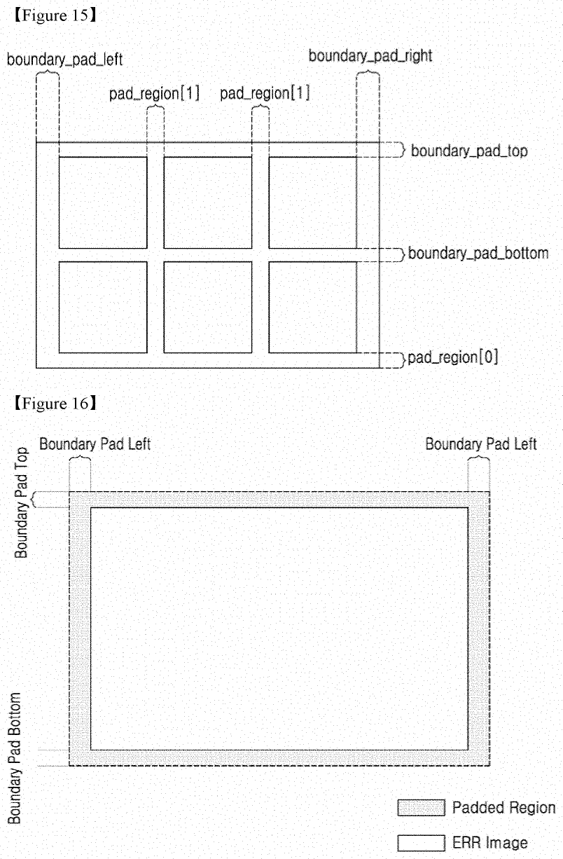

a. Discontinous boundary left at x=0, y=[0:image height] denoted as boundary_pad_left in the FIG. 15,

b. Discontinous boundary right at x=image width, y=[0:image height] denoted as boundary_pad_right in the FIG. 15,

c. Discontinous boundary top at x=[0:image width], y=0 denoted as boundary_pad_top in the FIG. 15,

d. Discontinous boundary bottom at x=[0:image width], y=image height denoted as boundary_pad_bottom in the FIG. 15,

e. Discontinous boundary between faces at x=[0:image width], y=face height denoted as pad_region[0] in the FIG. 15,

f. Discontinous boundary between faces at x=face width, y=[0:image height] denoted as pad_region[1] in the FIG. 15, and

g. Discontinous boundary between faces at x=(face width)*2, y=[0: image height] denoted as pad_region[1] in the FIG. 15.

3. If projection format is Rotated Sphere Projection (RSP) or other variants, the following are the discontinuous boundaries:

a. Discontinous boundary left at x=0, y=[0:image height] denoted as boundary_pad_left in the FIG. 17,

b. Discontinous boundary right at x=image width, y=[0:image height] denoted as boundary_pad_right in the FIG. 17,

c. Discontinous boundary top at x=[0:image width], y=0 denoted as boundary_pad_top in the FIG. 17,

d. Discontinous boundary bottom at x=[0:image width], y=image height denoted as boundary_pad_bottom in the FIG. 17,

e. Discontinous boundary between faces at x=[0:image width], y=face height denoted as pad_region[2] in the FIG. 17,

f. Discontinous boundary beyond face boundary curves denoted as pad_region[1] in the FIG. 17, and

g. Padding introduced to align the curved edges of RSP faces to block boundaries denoted as pad_region[0] in the FIG. 17.

The 360 degree image content generator 110 is configured to apply at least one padding information on the at least one discontinuous boundary. Further, the 360 degree image content generator 110 is configured to produce another 360 degree image content on the rectangular projection based on the padding information.

In an embodiment, the at least one padding information is obtained based on one of a signaling message and a metadata associated with the signaling message.

In an embodiment, the signaling message can be, for example, but not limited to a supplemental enhancement information (SEI) message, a Sequence Parameter Set (SPS) message, a Picture Parameter Set (PPS) message, and a Video Parameter Set (VPS) message. In an embodiment, the at least one padding information provides information about remapping at least one color sample of the 360 degree image content onto the rectangular projection.

In an embodiment, the at least one padding information includes at least one of a padding cancel parameter, a padding persistence parameter, a presence boundary indicating parameter, a boundary type, and a Chroma sample range value.

In an embodiment, the at least one padding information is applied on the at least one discontinuous boundary to manage a bleeding effect across the at least one discontinuous boundary in the another 360 degree image content.

In an embodiment, applying the at least one padding information on the at least one discontinuous boundary includes obtaining a set of frames, computing a difference value between a first frame from the set of frames and a second frame from the set of frames, determining whether the difference value between the first frame from the set of frames and the second frame from the set of frames meets a predefined value, and applying the at least one padding information on the at least one discontinuous boundary based on the determination. In an embodiment, the predefined value is computed as a function of a characteristic of the set of frames.

In an embodiment, the at least one padding information is applied on the at least one discontinuous boundary based on at least one of a size of a frame, a format of the projection segments, a resolution of the 360 degree image content, and an information about a projection type.

In an embodiment, the at least one padding information is applied on the at least one discontinuous boundary to align the at least one discontinuous boundary to at least one of a coding unit (CU) and a largest coding unit (LCU).

In an embodiment, the at least one padding information corresponds to at least one of a boundary based padding information and an internal based padding information.

In an example, a standard document (i.e., JCTVC-AB1005 document) specifies additional supplemental enhancement information (SEI) messages for omnidirectional 360° projection. Two projection methods (i.e., Equi-rectangular projection (ERP) methods and cubemap projection (CMP) methods) are specified in the standard document. The ERP SEI message provides information to enable remapping (through an equi-rectangular projection) of the colour samples of the projected pictures onto a sphere coordinate space in sphere coordinates (φ, θ) for use in omnidirectional video applications for which the viewing perspective is from the origin looking outward toward the inside of the sphere. The cubemap projection SEI message provides information to enable remapping (through a cubemap projection) of the colour samples of the projected pictures onto a sphere coordinate space in sphere coordinates (φ, θ) for use in the omnidirectional video applications for which the viewing perspective is from the origin looking outward toward the inside of the sphere. The standard document demonstrates the benefits of including padding information as the SEI message. Benefits of content dependent variable padding sizes are presented.

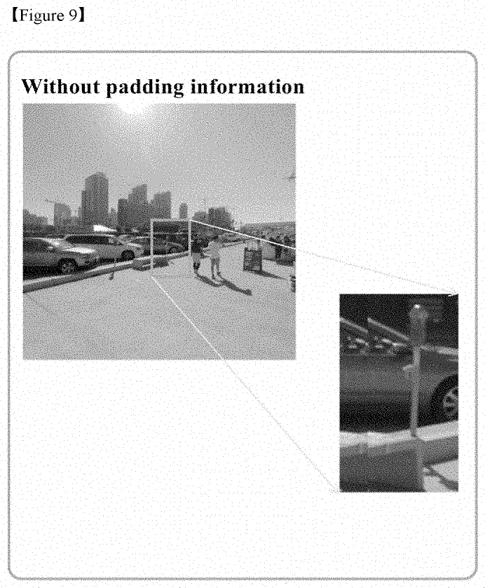

Another document (i.e., JVET-G0098 document) presented the benefits of including padding in ERP format. Different padding sizes are investigated and the impact of padding on visual artifacts are also presented. However, the padding information must also be transmitted to a decoder along with the bitstream in order to accurately be able to generate viewports from the decoded frames. FIG. 9 illustrates the viewport generated from padded ERP format when the padding size is not known.

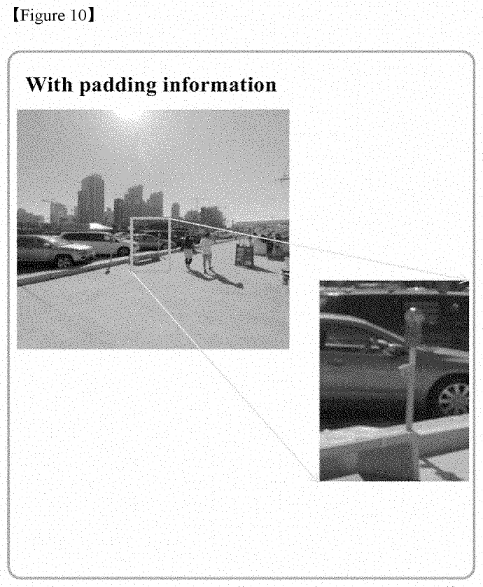

Further, the distinct seam is observed in the viewport when the padding information is not known to a decoder/renderer. The seam can be removed by transmitting the padding size and type information along with the bitstream. FIG. 10 illustrates the viewport when the decoder/renderer has information about the padding sizes.

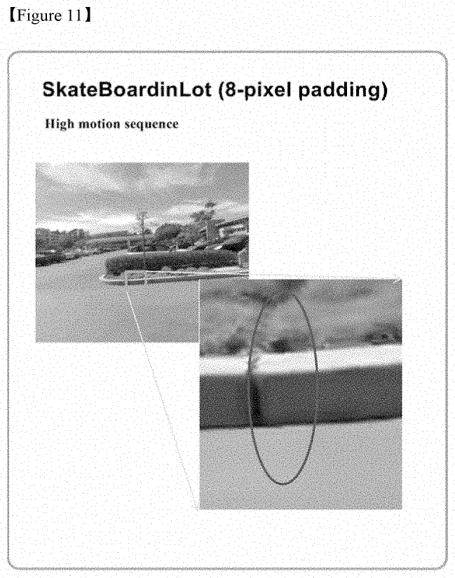

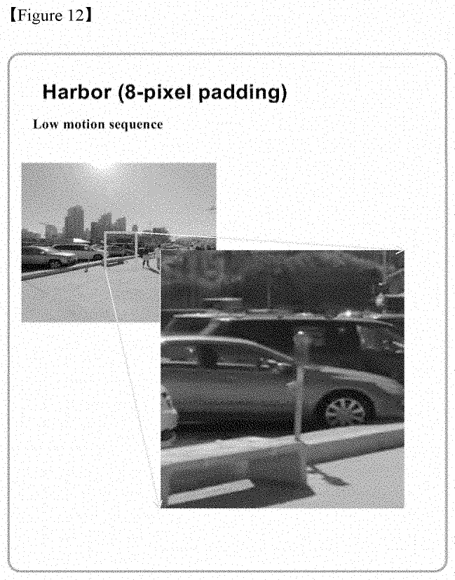

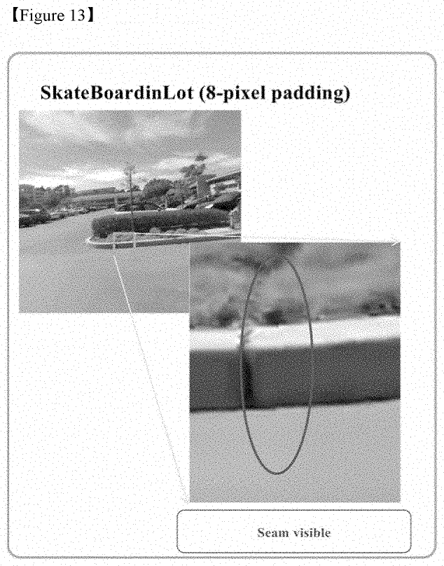

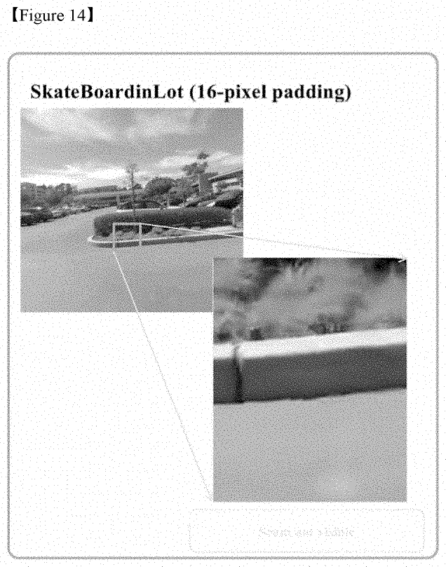

FIGS. 11 and 13 illustrate the viewport generated from padded ERP SkateboardinLot with 8 pixels padding. The seam is visible when the padding size is maintained at the edges. FIG. 12 shows the viewport generated from padded ERP of Harbor with 8 pixels padding. It can be seen that padding size of 8 pixels is sufficient for Harbor, which is largely stationary, whereas 16 pixel padding is required for SkateboardlnLot, which contains motion and is highly dynamic. FIG. 14 shows the viewport generated from padded ERP SkateboardinLot with 16 pixels padding. It can be seen that in case of SkateboardlnLot, more padding pixels is beneficial for the final image quality.

In an example, in the proposed methods, the method can be used to include signaling of padding size as the SEI message in addition to other Omnidirectional SEI messages. The padding SEI message is available only if equirectangular projection or cubemap projection SEI messages are present and regionwise packing SEI message is not present. In the proposed method, the electronic device 100 defines two types of padding in the projected picture, boundary padding and internal padding. Boundary padding is the padding done outside of the projected picture. Internal padding is when the padding pixels are within the projected picture.

In an example method, the padding information added in the SEI message is as follow depicted in table 1:

TABLE 1

Descriptor

sei_payload( payloadType, payloadSize ) {

if( nal_unit_type = = PREFIX_SEI_NUT )

if( payloadType = = XX )

omnidirectional_projection_indication( payloadSize)

else

reserved_sei_message( payloadSize)

}

}

Table 2 depicts omnidirectional padding information SEI message syntax information:

TABLE 2

Descriptor

omnidirectional_projection_indication( payloadSize) {

| | |
|---|---|
| omnidirectional_projection_indication_cancel_flag | u(1) |
| if( ! omnidirectional_projection_indication_cancel_flag ) { | |

| | |
|---|---|
| omni_projection_information_persistence_flag | u(1) |
| omni_projection_type | u(4) |
| omni_padding_flag | u(1) |
| if( omni_padding_flag) { | |

omni_padding( )

}

}

}

Further, padding information is provided as follows as indicated in the table 3:

TABLE 3

Descriptor

omni_padding( ) {

| | |
|---|---|
| omni_pad_cancel_flag | u(1) |
| if( ! omni_pad_cancel_flag ) { | |

| | |
|---|---|
| omni_pad_persistence_flag | u(1) |
| omni_boundary_padding_flag | u(1) |
| if( omni_boundary_padding_flag = = 1 ) { | |

| | |
|---|---|
| omni_boundary_padding_type | u(2) |
| omni_boundary_left_chroma_sample_range | u(8) |
| omni_boundary_right_chroma_sample_range | u(8) |
| omni_boundary_top_chroma_sample_range | u(8) |
| omni_boundary_bottom_chroma_sample_range | u(8) |

| | |
|---|---|
| } | |
| omni _num_internal_padding | u(3) |
| for( i = 0; i < omni_num_internal_padding; i++ ) { | |

| | |
|---|---|
| omni_internal_pad_type[i] | u(2) |
| omni_internal_pad_chroma_sample_range[i] | u(8) |

}

}

}

The omnidirectional projection information SEI message provides information to enable remapping the color samples of the projected picture onto projected pictures. When an omnidirectional projection information SEI message is present for any picture of a Cloud Live Video Streaming (CLVS) of a particular layer, either an omnidirectional projection information SEI message shall be present for the first picture of the CLVS.

The omnidirectional_projection_indication_cancel_flag parameter equal to 1 indicates that the SEI message cancels the persistence of any previous omnidirectional projection information SEI message in output order. The omnidirectional_projection_indication_cancel_flag parameter equal to 0 indicates that omnidirectional projection information follows.

Omni_projection_information_persistence_flag parameter specifies the persistence of the omnidirectional projection information SEI message for the current layer.

Omni_projection_information_persistence_flag parameter equal to 0 specifies that the omnidirectional projection information SEI message applies to a current decoded picture only.

Consider, let picture A be the current picture. omni_projection_information_persistence_flag parameter equal to 1 specifies that the omnidirectional projection information SEI message persists for the current layer in an output order until one or more of the following conditions are true:

a. A new CLVS of the current layer begins,

b. The bitstream ends, and

c. A picture picture-B in the current layer in an access unit containing the omnidirectional padding information SEI message that is applicable to the current layer is output for which PicOrderCnt (picB) is greater than PicOrderCnt (picA), where PicOrderCnt (picB) and PicOrderCnt (picA) are the PicOrderCntVal values of picB and picA, respectively, immediately after the invocation of the decoding process for picture order count for picB.

The omni_projection_type parameter equal to 0 indicates that the projection type is equi-rectangular projection. The omni_projection_type parameter equal to 1 indicates that the projection type is cube map projection. The omni_projection_type parameter equal to 2 indicates the projection type is a Hybrid Equiangular Cubemap projection. The omni_projection_type parameter equal to 3 indicates the projection type is an Equi-angular Cubemap projection. The omni_projection_type parameter equal to 4 indicates the projection type is a Rotated sphere projection.

Further, the omni_padding_flag parameter equal to 0 indicates padding is not present in the output image. The omni_padding_flag parameter equal to 1 indicates padding is present in the output image. The size and type of padding is described in the below section.

In the proposed method, the omnidirectional padding information SEI message provides information to enable remapping the color samples of the padded projected picture onto projected pictures. When an omnidirectional padding information SEI message is present for any picture of a CLVS of a particular layer, either a cubemap projection information SEI message or an equi-rectangular projection information SEI message shall be present for the first picture of the CLVS.

Further, the omni_boundary_padding_flag parameter equal to 1 indicates that the current decoded picture contains padding along the boundaries along with the projected picture.

The omni_boundary_padding_type parameter equal to 0 indicates that the sample values within the padding area are unspecified. The omni_boundary_padding_type parameter equal to 1 indicates that the value of each sample inside the padding area is equal to the value of the spatially nearest sample outside the padding area in the adjacent padded face. The omni_boundary_padding_type parameter equal to 2 indicates that the values of the samples inside the padding area equivalent to the values of the samples that are projected to the face neighbouring the padded face. The omni_boundary_padding_type parameter equal to 3 indicates that the values of samples inside the padding area are derived through projection to the extended planar surface of the face adjacent to the padding area.

omni_boundary_left_chroma_sample_range parameter indicates the thickness of the padding area on the left boundary of the decoded picture in units of chroma samples.

omni_boundary_right_chroma_sample_range parameter indicates the thickness of the padding area on the right boundary of the decoded picture in units of chroma samples.

omni_boundary_top_chroma_sample_range indicates the thickness of the padding area on the top boundary of the decoded picture in units of chroma samples.

omni_boundary_bottom_chroma_sample_range parameter indicates the thickness of the padding area on the bottom boundary of the decoded picture in units of chroma samples.

omni_num_internal_padding parameter indicates the number of internal padded areas present in the decoded picture. The value of omni_num_internal_padding shall be 0 when an equi-rectangular projection information SEI message is present for the first picture of the CLVS.

The value of omni_num_internal_padding shall be in the range of 0 to 2 when the cubemap projection information SEI message is present for the first picture of the CLVS. The value of omni_num_internal_padding equal to 0 indicates that there is no internal padding in the decoded picture. The value of omni_num_internal_padding equal to 1 indicates that there is internal padding at the pad_region 1 as indicated in the FIG. 15. The value of omni_num_internal_padding equal to 2 indicates that there is internal padding at the pad_region[0] and at pad_region[1] as indicated in the FIG. 15.

omni_internal_pad_type [i] equal to 0 indicates that the sample values within the padding area are unspecified. omni_boundary_padding_type [i] equal to 1 indicates that the value of each sample inside the padding area is equal to the value of the spatially nearest sample outside the padding area in the adjacent padded face. omni_boundary_padding_type [i] equal to 2 indicates that the values of the samples inside the padding area equivalent to the values of the samples that are projected to the face neighbouring the padded face. omni_boundary_padding_type [i] equal to 3 indicates that the values of samples inside the padding area are derived through projection to the extended planar surface of the face adjacent to the padding area.

omni_internal_pad_chroma_sample_range [i] indicates the thickness of the padding area on the bottom boundary of the decoded picture in units of chroma samples.

FIG. 15 is an example scenario in which padding regions are depicted in the Cubemap based formats. FIG. 16 is an example scenario in which padded regions are depicted in the Equi-rectangular projection format. FIG. 17 is an example scenario in which padded regions are depicted in rotated sphere projection format.

FIG. 7 is a block diagram of the 360 degree image content generator 110, according to embodiments as disclosed herein. In an embodiment, the 360 degree image content generator 110 includes a discontinuous boundary detector 110a and a padding information applier 110b. The discontinuous boundary detector 110a is configured to obtain the 360 degree image content represented by packing one or more projection segments arranged in the rectangular projection. Further, the discontinuous boundary detector 110a is configured to detect whether at least one discontinuous boundary is present in the 360-degree image content. Based on the detection, the padding information applier 110b is configured to apply at least one padding information on the at least one discontinuous boundary. Further, the padding information applier 110b is configured to produce another 360 degree image content on the rectangular projection in the electronic device based on the padding information.

Although the FIG. 7 shows various hardware components of the 360 degree image content generator 110 but it is to be understood that other embodiments are not limited thereon. In other embodiments, the 360 degree image content generator 110 may include less or more number of components. Further, the labels or names of the components are used only for illustrative purpose and does not limit the scope of the invention. One or more components can be combined together to perform same or substantially similar function to produce the 360 degree image content on the rectangular projection in the electronic device 100.

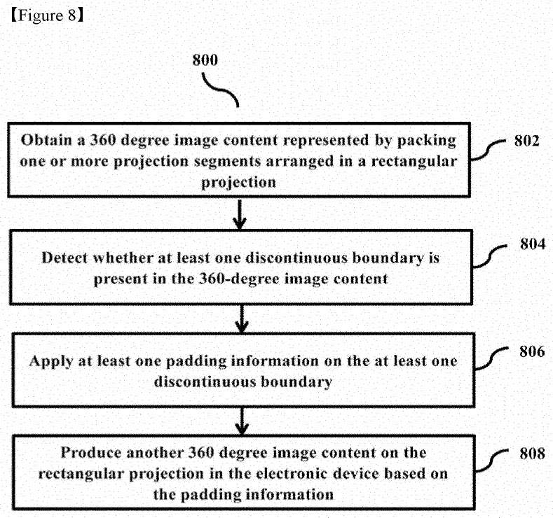

FIG. 8 is a flow diagram 300 illustrating a method for producing 360 degree image content on the rectangular projection in the electronic device 100, according to the embodiment as disclosed herein. The operations (802-808) are performed by the 360 degree image content generator 110.

At 802, the method includes obtaining the 360 degree image content represented by packing one or more projection segments arranged in the rectangular projection. At 804, the method includes detecting whether at least one discontinuous boundary is present in the 360-degree image content. The at least one discontinuous boundary is detected using the packing of one or more projection segments. At 806, the method includes applying at least one padding information on the at least one discontinuous boundary. At 808, the method includes producing another 360 degree image content on the rectangular projection in the electronic device based on the padding information.

The various actions, acts, blocks, steps, or the like in the flow diagram 800 may be performed in the order presented, in a different order or simultaneously. Further, in some embodiments, some of the actions, acts, blocks, steps, or the like may be omitted, added, modified, skipped, or the like without departing from the scope of the invention.

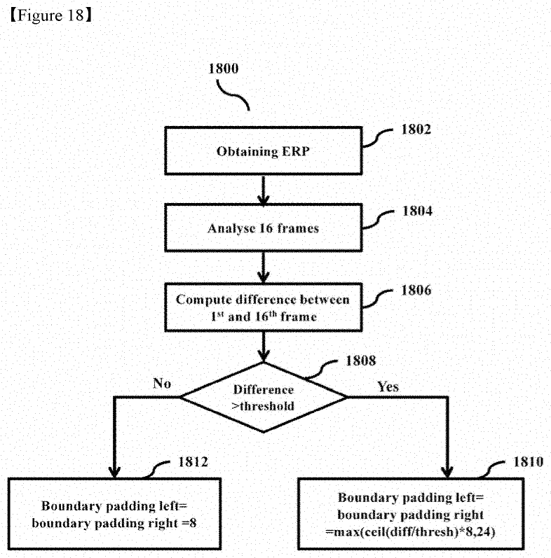

FIG. 18 is an example flow diagram 1800 illustrating various operations for applying the padding information on the at least one discontinuous boundary in the Equi-rectangular projection format, according to embodiments as disclosed herein. The operations (1802-1812) are performed by the padding information applier 110b.

At 1802, the method includes obtaining the 360 degree image content in the ERP format. At 1804, the method includes analyzing 16 frames. At 1806, the method includes computing a difference value between a first frame and the 16th frame. At 1808, the method includes determining whether the difference value between the first frame and 16th frame meets a predefined value. If the difference value is greater than the predefined value then at 1810, the method includes applying the value of boundary padding left or the value of the boundary padding right equal to max (ceil(diff/thresh)*8,24). If the difference value does not meet the predefined value then at 1812, the method includes applying the value of the boundary padding left and the value of the boundary padding right equal to 8.

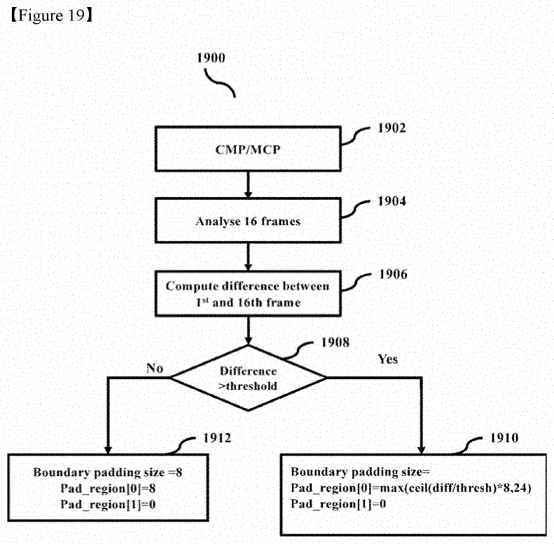

FIG. 19 is an example flow diagram 1900 illustrating various operations for applying the padding information on the at least one discontinuous boundary in the cubemap based projection format, according to embodiments as disclosed herein. The operations (1902-1912) are performed by the padding information applier 110b.

At 1902, the method includes obtaining the 360 degree image content in the CMP/MCP format. At 1904, the method includes analyzing 16 frames. At 1906, the method includes computing a difference value between a first frame and the 16th frame. At 1908, the method includes determining whether the difference value between the first frame and 16th frame meets a predefined value. If the difference value is greater than the predefined value then at 1910, the method includes applying the value of boundary padding size (i.e., Pad_region [0]=max (ceil (diff/thresh)*8, 24) and Pad_region [1]=0). If the difference value is less than the predefined value then at 1912, the method includes applying padding information (i.e., Boundary padding size=8, Pad_region [0]=8, and Pad_region [1]=0).

The various actions, acts, blocks, steps, or the like in the flow diagrams 1800 and 1900 may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the embodiments as described herein.

1. A method for producing 360 degree image content on a rectangular projection in an electronic device, comprising:
obtaining a 360 degree image content represented by packing one or more projection segments arranged in a rectangular projection;
detecting whether at least one discontinuous boundary is present in the 360-degree image content, wherein the at least one discontinuous boundary is detected using the packing of one or more projection segments;
applying at least one padding information on the at least one discontinuous boundary; and
producing another 360 degree image content on the rectangular projection in the electronic device based on the padding information.

2. The method of claim 1, wherein the at least one padding information is obtained based on one of a signaling message and a metadata associated with the signaling message.

3. The method of claim 2, wherein the signaling message comprises at least one of a supplemental enhancement information (SEI) message, a Sequence Parameter Set (SPS) message, a Picture Parameter Set (PPS) message, and a Video Parameter Set (VPS) message.

4. The method of claim 1, wherein the at least one padding information provides information about remapping at least one color sample of the 360 degree image content onto the rectangular projection.

5. The method of claim 1, wherein the at least one padding information comprises at least one of a padding cancel parameter, a padding persistence parameter, a presence boundary indicating parameter, a boundary type, and a Chroma sample range value.

6. The method of claim 1, wherein the at least one padding information is applied on the at least one discontinuous boundary to manage a bleeding effect across the at least one discontinuous boundary in the another 360 degree image content.

7. The method of claim 1, wherein applying the at least one padding information on the at least one discontinuous boundary comprises:
obtaining a set of frames;
computing a difference value between a first frame from the set of frames and a second frame from the set of frames;
determining whether the difference value between the first frame from the set of frames and the second frame from the set of frames meets a predefined value; and
applying the at least one padding information on the at least one discontinuous boundary based on the determination.

8. The method of claim 7, wherein the predefined value is computed as a function of a characteristic of the set of frames.

9. The method of claim 1, wherein the at least one padding information is applied on the at least one discontinuous boundary based on at least one of a size of a frame, a format of the projection segments, a resolution of the 360 degree image content, and an information about a projection type.

10. The method of claim 1, wherein the at least one padding information is applied on the at least one discontinuous boundary to align the at least one discontinuous boundary to at least one of a coding unit (CU) and a largest coding unit (LCU).

11. The method of claim 1, wherein the at least one padding information corresponds to at least one of a boundary based padding information and an internal based padding information.

12. An electronic device for producing 360 degree image content on a rectangular projection, comprising:
a processor;
a memory; and
a 360 degree image content generator, wherein the 360 degree image content generator, is coupled with the processor and the memory, configured for:
obtaining a 360 degree image content represented by packing one or more projection segments arranged in a rectangular projection;
detecting whether at least one discontinuous boundary is present in the 360-degree image content, wherein the at least one discontinuous boundary is detected using the packing of one or more projection segments;
applying at least one padding information on the at least one discontinuous boundary; and
producing another 360 degree image content on the rectangular projection in the electronic device based on the padding information.

13. The electronic device of claim 12, wherein the at least one padding information is obtained based on one of a signaling message and a metadata associated with the signaling message.

14. The electronic device of claim 12, wherein the at least one padding information comprises at least one of a padding cancel parameter, a padding persistence parameter, a presence boundary indicating parameter, a boundary type, and a Chroma sample range value.

15. The electronic device of claim 12, wherein applying the at least one padding information on the at least one discontinuous boundary comprises:
obtaining a set of frames;
computing a difference value between a first frame from the set of frames and a second frame from the set of frames;
determining whether the difference value between the first frame from the set of frames and the second frame from the set of frames meets a predefined value; and
applying the at least one padding information on the at least one discontinuous boundary based on the determination.
